(19) United States
(12) Patent Application Publication
(10) Pub. No.: US 2020/0048831 A1
(43) Pub. Date: Feb. 13, 2020

(54) PRIMARY BACKING FOR ARTIFICIAL TURF, METHOD FOR ITS MANUFACTURE AND ARTIFICIAL TURF COMPRISING THE PRIMARY BACKING

(71) Applicant: LOW & BONAR B.V., Arnhem (NL)

(72) Inventor: Arie VAN VLIET, (US)

(73) Assignee: LOW & BONAR B.V., Arnhem (NL)

(21) Appl. No.: 16/084,135

(22) PCT Filed: Mar. 14, 2017
(86) PCT No.: PCT/EP2017/055948

§ 371 Date: Sep. 11, 2018

(30) Foreign Application Priority Data
Mar. 18, 2016 (EP) 16161072.0

(51) Int. Cl. D06N 7/00; B32B 5/02; B32B 5/26; B32B 7/12; B32B 3/30; B32B 5/06; B32B 5/08; B32B 5/12; B32B 27/12

(52) U.S. Cl. CPC D06N 7/0068; D06N 2201/0281; B32B 5/024; B32B 5/26; B32B 7/12; B32B 3/30; B32B 5/06; B32B 5/08; B32B 5/12; B32B 27/12; B32B 2262/0261; B32B 2262/0253; B32B 2262/0276; B32B 2262/023; B32B 2262/0292; B32B 2250/20; B32B 2262/0215; B32B 2262/12; B32B 2410/00; D06N 2201/0209; D06N 2201/0254; D06N 2201/0263; B32B 5/022

(57) ABSTRACT

A primary backing having a component having a front surface and a rear surface, a second component having a front surface and a rear surface placed adjacent and plane-parallel to the first component, and an optional third component having a front surface and a rear surface placed adjacent and plane-parallel to the second component, wherein the first component comprises a two-dimensional material layer, an extruded sheet, and a non-woven fabric and/or a woven fabric. The second component comprises a three-dimensional structure, wherein the three-dimensional structure is build-up from macroscopic thermoplastic fibers, the fibers cross one another at crossing points and are thermally bonded to one another at their crossing points, and the third component comprises a further two-dimensional material layer, wherein the material layer comprises an extruded sheet, a non-woven fabric, a woven fabric and/or a two-dimensional layer of macroscopic fibers.

The present invention pertains to a primary backing for artificial turf, a method for its manufacture and an artificial turf comprising the primary backing.

WO 2015/185562 discloses an artificial turf comprising grass yarns tufted into a cushioning layer. The cushioning layer can be resilient foam, expanded structures of polymeric materials or extruded filaments in an open web acting as a carrier or primary backing. A preferred primary backing comprises a substrate onto which a lofty open web of inter-engaged continuously crinkled filaments is provided, i.e., the filaments are crinkled and are applied onto the substrate as a continuous spaghetti-like structure. These filaments are attached to the substrate by means of glueing and/or melting together part of the filaments at some or all points of mutual contact with the substrate to form an integrated structure. The substrate can be an extruded layer (possibly foamed) of a suitable polymeric material, e.g. applied on a reinforcing layer in a fluid state. The primary backing open web of inter-engaged continuously crinkled filaments is formed by
(I) extruding filaments into a water bath in order to cool down the extruded filaments,
(II) guiding the cooled filaments out of the water bath, and
(III) transporting the cooled filaments to another stage, where the filaments are bonded together with an adhesive, such as PVC, such that a continuous crinkled chain is formed,
(IV) further transporting the filaments chain down to a further stage, where filaments and substrate, provided with a reinforcing layer, are brought together and where part of the filaments are bonded, melted and/or welded at some or all points of mutual contact with the substrate.

So, the primary backing of WO 2015/185562 requires a laborious manufacturing process.

Therefore, the problem underlying the present invention is to provide a primary backing which can be manufactured in an easier manner.

Said problem is solved by a primary backing comprising at least a first component having a front surface and a rear surface, a second component having a front surface and a rear surface placed adjacent and plane-parallel to the first component, and optionally a third component having a front surface and a rear surface placed adjacent and plane-parallel to the second component, and wherein
the first component comprises a first two-dimensional material layer, wherein the first two-dimensional material layer comprises an extruded sheet, a non-woven fabric and/or a woven fabric,
the second component comprises a three-dimensional structure, wherein the three-dimensional structure is build-up from macroscopic fibers, the fibers cross one another at crossing points and are thermally bonded to one another at their crossing points, and
the third component comprises a further two-dimensional material layer, wherein the further two-dimensional material layer comprises an extruded sheet, a non-woven fabric, a woven fabric and/or a two-dimensional layer of macroscopic fibers.

Within the scope of the present invention the term “a first two-dimensional material layer” means a thin material layer having a thickness H_2Dfirst, a width W_2Dfirst, and a length L_2Dfirst. The values for W_2Dfirst and L_2Dfirst are in principle not limited. For practical reasons W_2Dfirst ranges preferably from 0.5 m to 10 m, more preferably from 0.75 m to 7.5 m, even more preferably from 0.95 m to 5 m, and especially preferred from 1.0 m to 5.0 m. The values for H_2Dfirst are limited to ≤2.0 mm, preferably to ≤1.5 mm, more preferred to ≤1.25 mm, and especially preferred are in the range from 0.2 mm to 1.0 mm.

Within the scope of the present invention the term “a further two-dimensional material layer” means a thin material layer having a thickness H_2Dfurther, a width W_2Dfurther, and a length L_2Dfurther. The values for W_2Dfurther and L_2Dfurther are in principle not limited. For practical reasons W_2Dfurther preferably ranges from 0.5 m to 10 m, more preferably from 0.75 m to 7.5 m, even more preferably from 0.95 m to 5 m, and especially preferred from 1.0 m to 5.0 m. The values for H_2Dfurther are limited to ≤10 mm, more preferred to ≤7.5 mm, and especially preferred are in the range from 0.2 mm to 5.0 mm.

Within the scope of the present invention the term “a three-dimensional structure” means a structure having a height H_3D, a width W_3D, and a length L_3D. The values for W_3D and L_3D are in principle not limited. For practical reasons W_3D ranges from 0.5 m to 10 m, more preferably from 0.75 m to 7.5 m, even more preferably from 0.95 m to ≥5 m, and especially preferred from 1.0 m to 5.0 m. The values for H_3D are limited to ≥5 mm more preferred to ≥7.5 mm, and especially preferred are in the range from 10 mm to 50 mm, in particular in the range from 10 mm to 30 mm.

The second component of the primary backing according to the present invention is preferably build-up from thermoplastic macroscopic fibers and/or from thermoplastic elastomeric macroscopic fibers, wherein the macroscopic fibers cross one another at crossing points and are thermally bonded to one to one another at their crossing points. As described later, this can be realized in only one dry process step instead of the process steps (I)-(III) which are needed in WO 2015/185562 to achieve bonded filaments.

Furthermore, the resulting second component comprises a three-dimensional structure, which is preferably build up from macroscopic fibers which only comprise thermoplastic polymer(s) and/or thermoplastic elastomeric polymer(s) without any adhesive, i.e., without any further material, so that recycling of the fibers into their fiber-forming polymer(s) is facilitated, especially if the three-dimensional structure is build up from macroscopic fibers which consist either of one thermoplastic polymer or of one thermoplastic elastomeric polymer.

Within the scope of the present invention the term “macroscopic fibers” refers to the diameter of the respective fibers which is much higher than the diameter of fibers in conventional non-woven fabrics. Said diameter of the macroscopic fibers is at least 0.1 mm. Preferably the macroscopic fibers of the second and third component have a diameter in the range from 0.1 to 2.5 mm, more preferred in the range from 0.2 to 2.0 mm, even more preferred in the range from 0.3 to 1.5 mm or 0.4 to 1.2 mm, and most preferred in the range from 0.5 to 0.8 mm.

The optionally present third component comprises a further two-dimensional material layer which enables to maintain an even distribution of the upright grass yarns across the surface of the artificial turf as the fibers of the further two-dimensional material layer prevent that grass yarns become entangled with neighboring grass yarns, e.g. due to forces applied by athletes for example during a game of soccer or another sport.

In one embodiment the further two-dimensional material layer comprises macroscopic fibers. The macroscopic fibers provide improved resistance against entanglement of neighboring grass yarns. Additionally, the further two-dimensional material layer of macroscopic fibers may be formed simultaneously with the three-dimensional structure in an integrated process.

In contrast, the fibers of the non-woven or woven fabric comprised by the first two dimensional material layer of the first component and the fibers of the non-woven or woven fabric comprised by the further two-dimensional material layer of the third component have a diameter below 100 μm, preferably below 75 μm, even more preferred in the range from 5 μm to 60 μm, and most preferred in the range from 10 μm to 50 μm.

In a preferred embodiment of the primary backing according to the present invention the first component is bonded with its front surface to the rear surface of the second component, and optionally the second component is bonded with its front surface to the rear surface of the third component.

In a further preferred embodiment of the primary backing according to the present invention bonding of the first to the second component and optionally of the second component to the third component is achieved by thermal bonding, by mechanical bonding, such as for example stitching, and/or with an adhesive.

Preferably, the first two-dimensional material layer of the first component and/or the further two-dimensional material layer of the third component is a thermoplastic material, more preferably a thermoplastic polymer, which preferably is selected from the group consisting of polyamides, polyolefines, such as polyethylenes or polypropylenes, polyesters or a blend of at least two of said polymers.

The extruded sheet comprised by the first two-dimensional material layer of the first component and/or the extruded sheet comprised by the further two-dimensional material layer of the third component is preferably manufactured from one of said thermoplastic polymers or is manufactured from a blend of at least two of said thermoplastic polymers.

The nonwoven fabric and/or the woven fabric comprised by the first two-dimensional material layer of the first component, and/or the nonwoven fabric and/or the woven fabric comprised by the further two-dimensional material layer of the third component are preferably manufactured of fibers using one of said thermoplastic polymers as the fiber-forming polymer.

Alternatively, the nonwoven fabric and/or the woven fabric comprised by the first two-dimensional material layer of the first component, and/or the nonwoven fabric and/or the woven fabric comprised by the further two-dimensional material layer of the third component may be manufactured from bicomponent fibers comprising a first fiber component and a second fiber component, wherein the first fiber component comprises one of said thermoplastic polymers, and the second fiber component comprises another of said thermoplastic polymers. The bicomponent fibers may have any cross-sectional configuration, such as for example side-by-side, segmented-pie or core/sheath configuration. Preferably, the bicomponent fibers have a core/sheath configuration for improved thermal bonding.

In another embodiment, the nonwoven fabric and/or the woven fabric comprised by the first two-dimensional material layer of the first component, and/or the nonwoven fabric and/or the woven fabric comprised by the further two-dimensional material layer of the third component may be manufactured from a mixture of at least a first fiber type and a second fiber type, wherein the first fiber type was manufactured using one of said thermoplastic polymers as the fiber-forming polymer, and the second fiber type was manufactured by another of said thermoplastic polymers as the fiber forming polymer.

In a preferred embodiment of the primary backing according to the present invention the first two-dimensional material layer and/or the further two-dimensional material layer comprises a non-woven fabric, and the non-woven fabric exhibits a two-dimensional structure which is build-up from thermoplastic fibers, wherein the fibers cross one another at crossing points and are thermally bonded to one another at their crossing points.

In a further preferred embodiment of the primary backing according to the present invention the second component comprises a three-dimensional structure, wherein the three-dimensional structure exhibits a constant density from the front surface to the rear surface.

In the primary backing according to the present invention the second component of the primary backing comprises a three-dimensional structure which is build-up from macroscopic fibers. Preferably, said macroscopic thermoplastic fibers are made from a thermoplastic polymer, and the thermoplastic polymer is selected from the group consisting of polyamides, polyolefines, polyesters or a blend of at least two of said polymers.

In another embodiment of the primary backing the second component comprises a three-dimensional structure which is build-up from macroscopic thermoplastic elastomeric fibers. Thermoplastic elastomeric fibers are a class of copolymers or a class of polymer blends which consists of materials with both thermoplastic and elastomeric properties. Thermoplastic elastomeric copolymers which may be used in the three dimensional structure of the second component may be segmented block copolymers consisting of stiff and flexible blocks or may be triblock copolymers of the ABA-type, such as for example a styrene-butadiene-styrene (SBS) copolymer. Thermoplastic elastomeric polymer blends which may be used in the three dimensional structure of the second component may consist of a thermoplastic polymer blended with an elastomeric polymer, such as for example a blend of polypropylene and EPDM rubber.

The thermoplastic elastomeric polymer (TPE) may be any type of thermoplastic elastomeric polymer, for example a thermoplastic polyolefin elastomeric polymer (TPO) such as for example a thermoplastic polypropylene elastomeric polymer, a thermoplastic polyester elastomeric polymer (TPC) such as for example sold under the Arnitel and Pibiflex name, a thermoplastic styrenic elastomeric polymer (TPS), or a thermoplastic elastomeric polyurethane polymer (TPU) such as for example sold under the Elastollan and Desmopan name, or a polyester based thermoplastic polyurethane polymer.

When the three-dimensional structure of the second component of the primary backing according to the present invention is made from a thermoplastic elastomeric polyester polymer, said polymer preferably comprises one or more stabilizing agents against hydrolysis.

In a further preferred embodiment of the primary backing according to the present invention the three-dimensional structure of the second component exhibits a u-groove, v-groove, or pyramidal structure.

Furthermore, a process to manufacture a primary backing as described above is part of the present invention. This process comprises the steps
a) providing a first component having a front surface and a rear surface, wherein the first component comprises a first two-dimensional material layer, wherein the first two-dimensional material layer comprises an extruded sheet, a non-woven fabric and/or a woven fabric,
b) providing a second component having a front surface and a rear surface, wherein the second component comprises a three-dimensional structure, wherein the three-dimensional structure is build-up from macroscopic fibers, the fibers cross one another at crossing points and are thermally bonded to one another at their crossing points, and optionally
c) providing a third component having a front surface and a rear surface, wherein the third component comprises a further two-dimensional material layer, wherein the further two-dimensional material layer comprises an extruded sheet, a non-woven fabric, a woven fabric, and/or a two-dimensional layer of macroscopic fibers,
d) arranging the front surface of the first component plane-parallel on the rear surface of the second component, and optionally
e) arranging the front surface of the second component plane-parallel on the rear surface of the third component.

In the process according to the present invention the terms “a first two-dimensional material layer”, “a further two-dimensional material layer”, “a three-dimensional structure”, “macroscopic fibers”, and “macroscopic elastomeric fibers” have analogously the same meaning as already explained for the primary backing of the present invention.

In step b) of the process according to the present invention the fibers cross one another at crossing points and are thermally bonded to one another at their crossing points so that no adhesive is needed. So, bonding of the fibers is realized in only one dry process step instead of the process steps (I)-(III) which are needed in WO 2015/185562 to achieve bonded filaments. Preferably, the second component provided in step b) comprises a three-dimensional structure, which is build up from macroscopic fibers which only comprise thermoplastic polymer(s) and/or thermoplastic elastomeric polymer(s) without any adhesive, i.e., without any further material, so that recycling of the fibers into their fiber-forming polymer(s) is facilitated, especially if the three-dimensional structure is build up from macroscopic fibers which consist either of one thermoplastic polymer or of one thermoplastic elastomeric polymer.

In a preferred embodiment (A) of the process according to the present invention the three-dimensional structure of the second component is manufactured by
i) melt-spinning of macroscopic thermoplastic fibers and/or of macroscopic thermoplastic elastomeric fibers into as-spun soft fibers,
ii) collecting the as-spun soft fibers onto a moving surface (a) so that the fibers cross one another at crossing points, wherein the moving surface (a) exhibits a three-dimensional texture which is invers to a desired three-dimensional structure of the second component, and allowing the as-spun soft fibers
   to orient themselves on the three-dimensional texture of the moving surface (a), wherein said orientation of the fibers is preferably exclusively driven by gravity, and
   to contact each other at their crossing points, so that the still soft fibers preferably penetrate one another to a certain extent, and
iii) cooling the fibers below a solidification temperature of the fibers so that the fibers are thermally bonded to one another at their crossing points.

The moving surface exhibiting a three-dimensional texture may for example be a profiled roll or a profiled belt.

In a further preferred embodiment (B) of the process according to the present invention the further two-dimensional structure of the third component is manufactured by
i)′ melt-spinning of macroscopic thermoplastic fibers and/or of macroscopic thermoplastic elastomeric fibers into as-spun soft fibers,
ii)′ placing the as-spun soft fibers onto a moving surface (b) so that the fibers cross one another at crossing points, wherein the moving surface (b) exhibits a surface without profile, and allowing the as-spun soft fibers
   to orient themselves on the moving surface without profile (b), wherein said orientation of the fibers is preferably exclusively driven by gravity, and
   to contact one another at their crossing points, so that the still soft fibers preferably penetrate one another to a certain extent and
iii)′ cooling the fibers below a solidification temperature of the fibers so that the fibers are thermally bonded to one another at their crossing points.

The moving surface without profile may for example be a smooth roll or a smooth belt.

In a further preferred embodiment of the process according to the present invention the three-dimensional structure of the second component and the two-dimensional structure of macroscopic fibers of the third component are formed simultaneously in an integrated process step (ips I) which may be realized as described in the following:

Both a moving substrate (a) as described in embodiment (A) and a moving substrate (b) as described in embodiment (B) are arranged below orifices of a common spin block. Macroscopic thermoplastic fibers and/or macroscopic thermoplastic elastomeric fibers are spun through said orifices and fall onto moving substrate (a) and onto moving substrate (b). On the three-dimensionally textured surface of moving substrate (a) the fibers are oriented and contact and preferably penetrate one another to a certain extent at their crossing points as described in step (ii) of the preferred embodiment (A). On the surface without profile of moving substrate (b) the fibers are oriented and contact and preferably penetrate one another to a certain extent at their crossing points as described in step (ii)′ of the preferred embodiment (B). The still soft fibers on moving substrates (a) are contacted with the still soft fibers on moving substrates (b). Said contacting can for example be realized in that moving substrate (a) is shaped as a roll (a) and moving substrate (b) is shaped as a roll (b), and roll (a) rotates in a rotation direction opposite to a rotation direction of roll (b) so that the fibers on moving substrate (a) are contacted with fibers on roll (b) in a nip which is formed between rolls (a) and (b). In the nip the surfaces of rolls (a) and (b) have a distance which ensures that the still soft fibers from moving substrate (a) are slightly pressed together with the still soft fibers from moving substrate (b) so that said fibers contact and preferably penetrate one another to a certain extent, and after having left the nip are cooled below a solidification temperature of the fibers thereby bonding the front surface of the second component to the rear surface of the third component.

Alternatively, the integrated process step (ip I) may be realized
with a moving substrate (a) as described in embodiment (A), wherein the moving substrate (a) is arranged below a first spinneret, and
a moving substrate (b) as described in embodiment (B), wherein the moving substrate (b) is arranged below a second spinneret,
   and wherein the first spinneret is arranged close to the second spinneret.

In a further preferred embodiment of the process according to the present invention bonding of the first component to the second component and formation of the three-dimensional structure of macroscopic fibers of the second component are executed simultaneously in an integrated process step (ips II) which may be realized as described in the following:

Steps (i) and (ii) of preferred embodiment (A) are practiced resulting in still soft macroscopic fibers which contact and preferably penetrate one another to a certain extent at their crossing points. Simultaneously a prefabricated first component comprising the first two-dimensional material layer shaped as an extruded sheet or as a non-woven fabric or as a woven fabric is contacted in a contact zone with and slightly pressed on the still soft macroscopic fibers on the moving surface (a) exhibiting a three-dimensional texture so that macroscopic fibers contact and preferably penetrate to a certain extent into the fibers of the nonwoven fabric or woven fabric of the first two-dimensional material layer or contact and preferably penetrate to a certain extent into the extruded sheet, respectively. After leaving the contact zone and cooling below the solidification temperatures of the first and second component the front surface of the first component is thermally bonded to the rear surface of the second component. Preferably, the fibers of the (non-)woven fabric and/or the extruded sheet of the first two-dimensional material layer has/have been preheated above their respective softening points to improve the bonding strength between the first two-dimensional material layer and the three-dimensional structure.

The primary backing is used to manufacture an artificial turf by tufting of the primary backing according to the present invention with grass yarns. So, an artificial turf obtained by tufting the primary backing according to the present invention or the primary backing resulting from the process according to the present invention with grass yarns is also part of the present invention.

As already mentioned, the optionally present further two-dimensional material layer of the third component enables an even distribution of the upright grass yarns across the surface of the artificial turf as said upright standing of the grass yarns is in particular supported by the first two-dimensional material layer of the first component, and by the further two-dimensional material layer of the third component, preferably being located approximately 1 cm to 3 cm higher than the two-dimensional layer of the first component.

Especially, the combination of the first, second, and third component cause a high stabilization of the upright alignment of the grass yarns across the artificial turf over the years. Furthermore, the primary backing helps the artificial turf to create additional horizontal drainage and extra player comfort, because the primary backing provides increased shock absorbance and improved vertical deformation. Also ball rebound characteristics is improved by the primary backing.

Preferably, the grass yarns are manufactured from fibers made of thermoplastic polymer(s), preferably from polyamide(s), polyester(s), polyolefine(s), such as polyethylenes or polypropylenes, or a blend of at least two of said polymers.

1. A primary backing comprising
a first component having a front surface and a rear surface, and
a second component having a front surface and a rear surface placed adjacent and plane-parallel to the first component, and
wherein the first component comprises a first two-dimensional material layer, wherein the first two-dimensional material layer comprises an extruded sheet, a non-woven fabric and/or a woven fabric, and
wherein the second component comprises a three-dimensional structure, wherein the three-dimensional structure is built-up from macroscopic fibers, wherein the fibers cross one another at crossing points and are thermally bonded to one another at their crossing points.

2. The primary backing according to claim 1, wherein the first component is bonded with its front surface to the rear surface of the second component.

3. The primary backing according to claim 2, wherein bonding of the first to the second component is achieved by thermal bonding, by mechanical bonding and/or with an adhesive.

4. The primary backing according to claim 1, wherein the first two-dimensional material layer of the first component is a thermoplastic material.

5. The primary backing according to claim 1, wherein the second component comprises a three-dimensional structure, wherein the three-dimensional structure exhibits a constant density from the front surface to the rear surface.

6. The primary backing according to claim 1, wherein the macroscopic fibers in the second component are made from a thermoplastic polymer, and the thermoplastic polymer is selected from the group consisting of polyamides, polyolefins, polyesters or a blend of at least two of said polymers.

7. The primary backing according to claim 1, wherein the macroscopic fibers in the second component are made from a thermoplastic polyolefin elastomeric polymer (TPO), a thermoplastic polyester elastomeric polymer (TPC), a thermoplastic styrenic elastomeric polymer (TPS), or a thermoplastic elastomeric polyurethane polymer (TPU), or a polyester based thermoplastic polyurethane polymer.

8. The primary backing according to claim 1, wherein the first two-dimensional material layer comprises a non-woven fabric, and the non-woven fabric exhibits a two-dimensional structure which is built-up from thermoplastic fibers, wherein the fibers cross one another at crossing points and are thermally bonded to one another at their crossing points.

9. The primary backing according to claim 1, wherein the three-dimensional structure of the second component exhibits a u-groove, v-groove, or pyramidal structure.

10. A process to manufacture a primary backing according to claim 1 comprising the steps
a) providing a first component having a front surface and a rear surface, wherein the first component comprises a first two-dimensional material layer, wherein the first two-dimensional material layer comprises an extruded sheet, a non-woven fabric and/or a woven fabric,
b) providing a second component having a front surface and a rear surface, wherein the second component comprises a three-dimensional structure, wherein the three-dimensional structure is built-up from macroscopic fibers, wherein the fibers cross one another at crossing points and are thermally bonded to one another at their crossing points, and
c) arranging the front surface of the first component plane-parallel on the rear surface of the second component.

11. A process according to claim 10, wherein the three-dimensional structure of the second component is manufactured by
i) melt-spinning of macroscopic thermoplastic fibers and/or of macroscopic thermoplastic elastomeric fibers into as-spun soft fibers,
ii) collecting the as-spun soft fibers onto a moving surface so that the fibers cross one another at crossing points, wherein the moving surface exhibits a three-dimensional texture which is invers to a desired three-dimensional structure of the second component, and allowing the fibers to orient themselves on the three-dimensional texture of the moving surface, and to contact each other at their crossing points and
iii) cooling the fibers below a solidification temperature of the fibers.

12. A process according to claim 20, wherein the further two-dimensional structure of the third component is manufactured by
i) melt-spinning of macroscopic thermoplastic fibers into as-spun soft fibers,
ii) placing the as-spun soft fibers onto a moving surface so that the fibers cross one another at crossing points, wherein the moving surface exhibits a surface without profile, and allowing the as-spun soft fibers to orient themselves on the moving surface, and to contact one another at their crossing points, and
iii) cooling the fibers below a solidification temperature of the fibers.

13. The process according to claim 20, wherein the three-dimensional structure of the second component and the two-dimensional structure of macroscopic fibers of the third component are formed simultaneously in an integrated process step (ips I).

14. The process according to claim 10, wherein the bonding of the first component to the second component and the formation of the three-dimensional structure of macroscopic fibers of the second component are executed simultaneously in an integrated process step (ips II).

15. An artificial turf obtained by tufting the primary backing according to claim 1.

16. The primary backing obtained by the process according to claim 10 with grass yarns.

17. The primary backing according to claim 1, wherein
the primary backing further comprises a third component having a front surface and a rear surface placed adjacent and plane-parallel to the second component, the third component comprising a further two-dimensional material layer, wherein the further two-dimensional material layer comprises an extruded sheet, a non-woven fabric, a woven fabric and/or a two-dimensional layer of macroscopic fibers.

18. The primary backing according to claim 17, wherein the second component is bonded with its front surface to the rear surface of the third component.

19. The primary backing according to claim 18, wherein bonding of the second component to the third component is achieved by thermal bonding, by mechanical bonding and/or with an adhesive.

20. A process to manufacture a primary backing according to claim 10, further comprising the steps
providing a third component having a front surface and a rear surface, wherein the third component comprises a further two-dimensional material layer, wherein the further two-dimensional material layer comprises an extruded sheet, a non-woven fabric, a woven fabric, and/or a two-dimensional layer of macroscopic fibers, and
arranging the front surface of the second component plane-parallel on the rear surface of the third component.
